(19) United States
(12) Patent Application Publication
(10) Pub. No.: US 2024/0284551 A1
(43) Pub. Date: Aug. 22, 2024

(54) Method And Apparatus For Network Discontinuous Transmission And User Equipment Discontinuous Reception Alignment In Mobile Communications

(71) Applicant: MediaTek Inc., Hsinchu City (TW)

(72) Inventors: Chien-Chun Cheng, Hsinchu City (TW); Mu-Tai Lin, Hsinchu City (TW); Wei-De Wu, Hsinchu City (TW); Yi-Ju Liao, Hsinchu City (TW); Cheng-Hsun Li, Hsinchu City (TW)

(21) Appl. No.: 18/521,625

(22) Filed: Nov. 28, 2023

Related U.S. Application Data
(60) Provisional application No. 63/485,549, filed on Feb. 17, 2023.

(51) Int. Cl. H04W 76/28; H04W 52/02; H04W 72/12; H04W 72/232

(52) U.S. Cl. CPC H04W 76/28; H04W 52/0235; H04W 72/12; H04W 72/232

(57) ABSTRACT

Examples pertaining to cell discontinuous transmission (DTX) and user equipment (UE) discontinuous reception (DRX) are described. A UE receives a configuration of a cell DTX from a network node with a cell DTX functionality. The configuration carries information regarding at least one of a periodicity, a start slot or a start offset and an on duration. Then, the UE skips a monitoring activity during one or more non-active periods of the cell DTX of the network node.

### CROSS REFERENCE TO RELATED PATENT APPLICATION(S)

The present disclosure is part of a non-provisional application claiming the priority benefit of U.S. Patent Application No. 63/485,549, filed 17 Feb. 2023, the content of which herein being incorporated by reference in its entirety.

### TECHNICAL FIELD

The present disclosure is generally related to mobile communications and, more particularly, to network or cell discontinue transmission (DTX) and user equipment (UE) discontinue reception (DRX) alignment to achieve power saving (PS) with respect to UE and network apparatus in mobile communications.

### BACKGROUND

Unless otherwise indicated herein, approaches described in this section are not prior art to the claims listed below and are not admitted as prior art by inclusion in this section.

The fifth-generation (5G) network, despite its enhanced energy efficiency in bits per Joule (e.g., 417% more efficiency than a 4G network) due to its larger bandwidth and better spatial multiplexing capabilities, may consume over 140% more energy than a 4G network.

Therefore, it is important to achieve 5G network power savings. There are many conflicts among performance metrics. Quality of service (QOS) and power savings may need a tradeoff. Some local optimal solutions may not achieve the global/overall optimum. For example, the wake-up signal (WUS) saving user equipment power by 20% may degrade 30% of base station power savings. However, it would be beneficial to get more BS sleep time for 5G network power savings.

Accordingly, how to achieve network power saving becomes an important issue for the newly developed wireless communication network. Therefore, there is a need to provide proper schemes for network power saving.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to network power saving (PS) with respect to a communication apparatus (e.g., a UE) and a network apparatus (e.g., a network node or a base station (BS), such as a next generation Node B (gNB)) in mobile communications.

In one aspect, a method may involve an apparatus aligning reception behaviors with transmission of a network node. The method may also involve the apparatus receiving a configuration of a cell discontinuous transmission (DTX) from the network node with a cell DTX functionality via a processor of the apparatus and skipping a monitoring activity during one or more non-active periods of the cell DTX of the network node. The configuration comprises information regarding at least one of a periodicity, a start slot or a start offset and an on duration.

In one aspect, an apparatus may involve a transceiver which, during operation, wirelessly communicates with at least one network node. The apparatus may also involve a processor communicatively coupled to the transceiver such that, during operation, the processor performs following operations: receiving, via the transceiver, a configuration of a cell discontinuous transmission (DTX) from the network node with a cell DTX functionality; and skipping a monitoring activity during one or more non-active periods of the cell DTX of the network node. The configuration comprises information regarding at least one of a periodicity, a start slot or a start offset and an on duration.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of skipping PDCCH monitoring under schemes in accordance with implementations of the present disclosure.

FIG. 2 is a diagram depicting an example scenario of determining not to start the dtx-onDurationTimer for the next DTX cycle under schemes in accordance with implementations of the present disclosure.

FIG. 3 is a diagram depicting another example scenario of skipping PDCCH monitoring under schemes in accordance with implementations of the present disclosure.

FIG. 4 is a diagram depicting yet another example scenario of skipping PDCCH monitoring under schemes in accordance with implementations of the present disclosure.

FIG. 5 is a block diagram of an example communication system in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to network or cell DTX and UE DRX alignment for network energy saving. According to the present disclosure, a number of possible solutions may be implemented separately or jointly. That is, although these possible solutions may be described below separately, two or more of these possible solutions may be implemented in one combination or another.

The present disclosure proposes several schemes pertaining to network power saving (or network energy saving) with respect to a communication apparatus (e.g., a UE) and a network apparatus in mobile communications.

In some implementations, cell DTX or DRX may be applied to at least the UEs in an RRC connected state. A periodic cell DTX or DRX (i.e., including active periods and non-active periods of the network node) may be configured by the network node via UE-specific RRC signaling per serving cell.

In some implementations, the UE may receive a configuration of a cell DTX from the network node with the cell DTX functionality. In some implementations, the configuration may comprise or carry information regarding at least one of a periodicity, a start slot or a start offset and an on duration with respect to the cell DTX. In some implementations, the UE may skip a monitoring activity during one or more non-active periods of the cell DTX of the network node, to align the UE DRX with the cell DTX.

In some implementations, the monitoring activity may comprise a monitoring activity to monitor a physical downlink control channel (PDCCH) scrambled with a cell radio network temporary identifier (C-RNTI) of the apparatus.

In some implementations, the monitoring activity may comprise a monitoring activity to monitor a Type3-PDCCH common search space (CSS).

In some implementations, behaviors of the cell DTX or DRX during non-active periods may comprise one or more of the following examples: (1) The UE is expected to skip all transmission and reception for data traffic and reference signal during the cell DTX or DRX non-active periods. (2) The UE is expected to skip its transmission or reception only for data traffic during the cell DTX or DRX non-active periods (i.e., the network node may still transmit or receive reference signals). (3) The UE is expected to skip its dynamic data transmission or reception during the cell DTX or DRX non-active periods (i.e., the UE is expected to still perform transmission or reception in periodic resources, including semi-persistent scheduling (SPS), cell group physical uplink shared channel (CG-PUSCH), scheduling request (SR), random access channel (RACH), and sounding reference signal (SRS)). (4) The UE is expected to skip its new dynamic data transmission or reception during the cell DTX or DRX non-active periods (i.e., the UE is expected to still perform transmission or reception for dynamic data retransmissions). (5) The UE is expected to only receive reference signals (e.g., synchronization signal block (SSB) or channel status information reference signal (CSI-RS) for measurement).

In some implementations, legacy UEs may access cells with the cell DTX or DRX functionality if a cell barred parameter in the acquired master information block (MIB) is not set to barred. The legacy UE may perform legacy behaviors in the cells with the cell DTX or DRX functionality.

In some implementations, the cell DTX or DRX mode may be activated or deactivated via dynamic layer 1 (L1) signaling (such as a PDCCH-based signaling) or layer 2 (L2) signaling, or UE-specific RRC signaling. The UE may receive both UE specific and common L1 or L2 signaling for activating/deactivating the cell DTX or DRX mode.

In some implementations, before activating/deactivating the cell DTX or DRX mode, the UE may report its capability of using or supporting the cell DTX/DRX (e.g., capability of recognizing the provided a pattern or a configuration of the cell DTX or DRX) to the network node. The network node may transmit the configuration of the cell DTX or DRX when confirming that the UE supports the cell DTX/DRX.

In some implementations, the UE may receive a cell DTX activation or deactivation indication from the network node via a RRC signaling or a PDCCH-based signaling, such as a downlink control information (DCI). In some implementations, the PDCCH-based signaling comprises at least one of a DCI format 2_6 and a DCI format 2_7.

In some implementations, the cell DTX and cell DRX modes may be configured and operated separately (e.g., one RRC configuration set for downlink (DL) and another for uplink (UL)). The cell DTX and cell DRX may also be configured and operated together. In some implementations, at least the following parameters may be configured per cell DTX/DRX configuration: a periodicity, a start slot or a start offset, and an on duration.

In some implementations, in receiving the configuration, the UE may receive a RRC signaling from the network node to configure one or more cell DTX parameters, e.g., a periodic cell DTX/DRX pattern may be configured by UE specific RRC signaling. The one or more cell DTX parameters may comprise at least one of the periodicity, the start slot or the start offset and the on duration.

In some implementations, the on duration may be indicated by a cell DTX on duration timer. In some implementations, the start offset may be indicated by a slot offset or a start slot.

In some implementations, the periodicity configured to the UE may comprises at least one of a cell DTX long cycle and a cell DTX short cycle.

In some implementations, if the UE is configured both UE DRX and cell DTX or DRX, the UE may skip the PDCCH monitoring (e.g., the monitoring activity to monitor the PDCCH) according to the intersection of PDCCH monitoring occasions controlled by the cell DTX or DRX and the UE DRX.

Regarding the UE DRX, the UE may be configured, via the RRC, by the network node with a cell DTX functionality that controls the UE's PDCCH monitoring activity for UE's C-RNTI, cancellation indication (CI) RNTI (CI-RNTI), configured scheduling RNTI (CS-RNTI), interruption RNTI (INT-RNTI), slot format indication RNTI (SFI-RNTI), semi-persistent CSI RNTI (SP-CSI-RNTI), transmit power control (TPC) physical uplink control channel (PUCCH) RNTI (TPC-PUCCH-RNTI), TPC-PUSCH-RNTI, TPC-SRS-RNTI, availability indication (AI) RNTI (AI-RNTI), side link (SL) RNTI (SL-RNTI), SL configured scheduling (SLCS) RNTI (SLCS-RNTI) and SL Semi-Persistent Scheduling vehicle RNTI (V-RNTI).

In some implementations, when using the cell DTX operation, the UE may also monitor PDCCH according to requirements found in other clauses of this specification. When in the RRC connected state, if the cell DTX is configured, for all the activated serving cells, the UE may monitor the PDCCH discontinuously using the cell DTX operation.

In some implementations, the UE may receive a RRC signaling with an information element (IE) for cell DTX operation by configuring the following parameters:
dtx-onDuration Timer: the duration at the beginning of a DTX cycle. The dtx-onDurationTimer may be a timer to indicate the on duration.
dtx-SlotOffset: the delay before starting the dtx-onDurationTimer. The start offset or delay may be indicated by the slot offset or the start slot.
dtx-LongCycleStartOffset: the Long DTX cycle, dtx-LongCycle, and the start offset, dtx-StartOffset, which defines the subframe where the Long and Short Cell DTX cycle starts.
dtx-ShortCycle: the Short DTX cycle.
dtx-HARQ-RTT-TimerDL (per DL Hybrid Automatic Repeat reQuest (HARQ) process except for the broadcast process): the minimum duration before a DL assignment for HARQ retransmission is expected by UE.
dtx-Retransmission TimerDL: (per DL HARQ process except for the broadcast process): the maximum duration until a DL retransmission is received.
dtx-Inactivity Timer.

In some implementations, the UE may receive two cell DTX groups with separate cell DTX parameters. When two cell DTX groups are configured, each serving cell is uniquely assigned to either of the two groups.

In some implementations, if the UE is configured cell DTX and DRX, the active time for serving cells in a DRX or a DTX group may include the time while: (1) dtx-on DurationTimer or dtx-Inactivity Timer configured for the cell DTX group is running; or (2) dtx-RetransmissionTimerDL is running on any serving cell in the DTX group; or (3) drx-onDurationTimer or drx-InactivityTimer configured for the DRX group is running; or (4) drx-RetransmissionTimerDL, drx-RetransmissionTimerUL or drx-RetransmissionTimerSL is running on any serving cell in the DRX group; or (5) ra-ContentionResolutionTimer or msgB-ResponseWindow is running; or (6) an SR is sent on PUCCH and is pending. If this serving cell is part of a non-terrestrial network, the active time is started after the SR transmission that is performed when the SR_COUNTER is 0 for all the SR configurations with pending SR(s) plus the UE-gNB round trip time (RTT); or (7) a PDCCH indicating a new transmission addressed to the C-RNTI of UE has not been received after successful reception of a random access response for the random access preamble not selected by UE among the contention-based random access preamble.

In some implementations, the UE may perform a transmission activity to send an SR in an active period of the DRX (either the UE DRX or the cell DRX) and an active period of the cell DTX of the network node, or the UE may skip a transmission of the SR during one or more non-active periods of the DRX (either the UE DRX or the cell DRX) or one or more non-active periods of the cell DTX of the network node.

In some implementations, if the long cell DTX cycle is used for a cell DTX group, and [(system frame number (SFN)×10)+subframe number] modulo (dtx-LongCycle)=dtx-StartOffset, the UE may start the dtx-onDuration Timer for this DTX group after dtx-SlotOffset from the beginning of the subframe.

In some implementations, if the short DRX cycle is used for a DRX group, and [(SFN×10)+subframe number] modulo (dtx-ShortCycle)=(dtx-StartOffset) modulo (dtx-ShortCycle), the UE may start the dtx-onDuration Timer for this DTX group after dtx-SlotOffset from the beginning of the subframe.

In some implementations, if a DRX or a DTX group is in the active time, the UE may monitor the PDCCH on the serving cells in this DTX group; or start or restart the dtx-HARQ-RTT-TimerDL for the corresponding HARQ process(es) whose HARQ feedback is reported in the first symbol after the end of the corresponding transmission carrying the DL HARQ feedback, if the PDCCH indicates a DL transmission, or if the PDCCH indicates a retransmission.

In some implementations, if a dtx-HARQ-RTT-TimerDL expires and if the data of the corresponding HARQ process was not successfully decoded, UE may start the dtx-RetransmissionTimerDL for the corresponding HARQ process in the first symbol after the expiry of the dtx-HARQ-RTT-TimerDL.

In some implementations, if a DRX or a DTX group is in the active time and if the PDCCH indicates a new transmission (DL, UL or SL) on a serving cell in this DTX group, the UE may start or restart the dtx-Inactivity Timer for this DTX group in the first symbol after the end of the PDCCH reception.

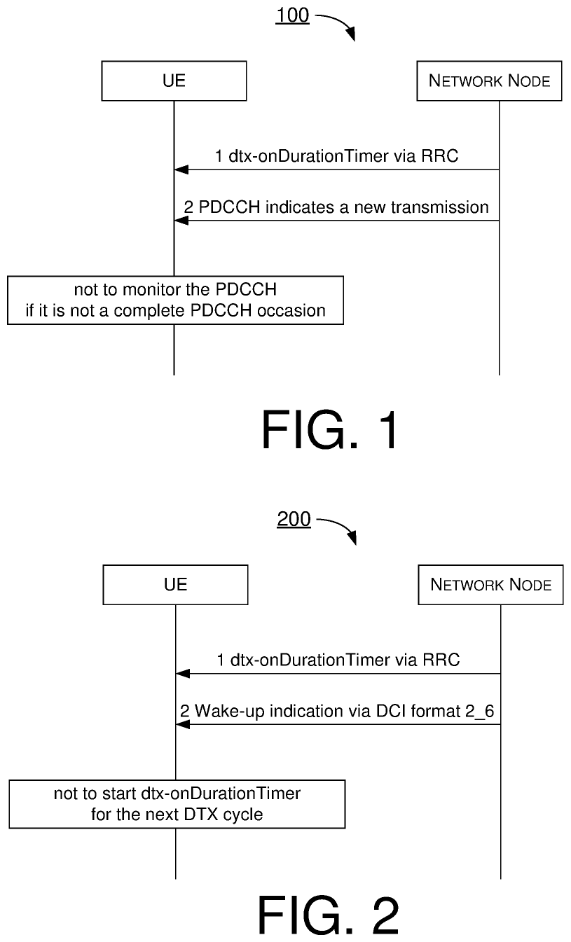

FIG. 1 illustrates an example scenario 100 of skipping PDCCH monitoring under schemes in accordance with implementations of the present disclosure. In some implementations, the UE may not need to monitor the PDCCH, or the UE may early terminate PDCCH monitoring if it is not a complete PDCCH occasion (e.g., the active time starts or ends in the middle of a PDCCH occasion, controlled by cell DTX configurations).

In some implementations, the UE may receive an indication of a new transmission from the network node. The UE may skip a monitoring activity to monitor a PDCCH occasion for the new transmission in an event that the PDCCH occasion is overlapped with one of the one or more non-active periods of the cell DTX.

Regarding PDCCH monitoring indication and dormancy/non-dormancy behavior for secondary cells (SCells), the UE configured with DRX mode operation or DTX mode operation may be provided the following for detection of a DCI format 2_6 in a PDCCH reception on the primary cell (PCell) or on the special cell (SpCell): (1) a location in DCI format 2_6 of a wake-up indication bit by ps-Position DCI-2-6; or (2) a bitmap, when the UE is provided a number of groups of configured SCells by dormancyGroupOutsideActiveTime; the bitmap location is immediately after the wake-up indication bit location.

FIG. 2 illustrates an example scenario 200 of determining not to start the dtx-onDurationTimer for the next DTX cycle under schemes in accordance with implementations of the present disclosure. In some implementations, the UE may receive a DCI format 2_6 including a location in DCI format 2_6 of a wake-up indication bit by ps-PositionDCI-2-6, where a ‘0’ value for the wake-up indication bit, when reported to higher layers, indicates to not start the drx-onDurationTimer for the next long DRX cycle, or not start the dtx-onDuration Timer for the next long DTX cycle, while a ‘1’ value for the wake-up indication bit, when reported to higher layers, indicates to start the drx-onDuration Timer for the next long DRX cycle, or start the dtx-onDurationTimer for the next long DTX cycle.

In some implementations, on PDCCH monitoring occasions associated with a same long DRX Cycle or long DTX cycle, the UE may not expect to detect more than one DCI format 2_6 with different values of the wake-up indication bit for the UE or with different values of the bitmap for the UE.

In some implementations, the UE does not monitor PDCCH for detecting DCI format 2_6 during the active time controlled by cell DTX or DRX configurations or operations.

In some implementations, if the UE is provided search space sets to monitor PDCCH for detection of DCI format 2_6 in the active DL bandwidth part (BWP) of the PCell or of the SpCell and the UE detects DCI format 2_6, the physical layer of the UE reports the value of the wake-up indication bit for the UE to higher layers for the next long DRX cycle or long DTX cycle.

In some implementations, if a UE is provided search space sets to monitor PDCCH for detection of DCI format 2_6 in the active DL BWP of the PCell or of the SpCell and the UE does not detect DCI format 2_6, the physical layer of the UE does not report a value of the wake-up indication bit to higher layers for the next long DRX cycle or the next long DTX cycle.

In some implementations, if a UE is provided search space sets to monitor PDCCH for detection of DCI format 2_6 in the active DL BWP of the PCell or of the SpCell, UE may not be required to monitor PDCCH for detection of DCI format 2_6 for all corresponding PDCCH monitoring occasions outside active time prior to a next long DRX cycle or a next long DTX cycle, or the UE may not have any PDCCH monitoring occasions for detection of DCI format 2_6 outside active time of a next long DRX cycle or long DTX cycle.

Regarding search space set group switching and skipping of PDCCH monitoring, in some implementations, the UE may be provided a group index for a respective Type3-PDCCH CSS set or UE-specific search space (USS) set by searchSpaceGroupIdList for PDCCH monitoring on a serving cell. When the UE is provided searchSpaceGroupIdList, the UE may reset PDCCH monitoring according to search space sets with group index 0, if provided by searchSpaceGroupIdList.

In some implementations, the UE may be provided, by searchSpaceSwitchTimer, a timer value for a serving cell that the UE is provided by RRC. The UE may decrement the timer value by one after each slot based on a reference SCS configuration that is the smallest SCS configuration among all configured DL BWPs in the serving cell, or in the set of serving cells. The UE maintains the reference SCS configuration during the timer decrement procedure.

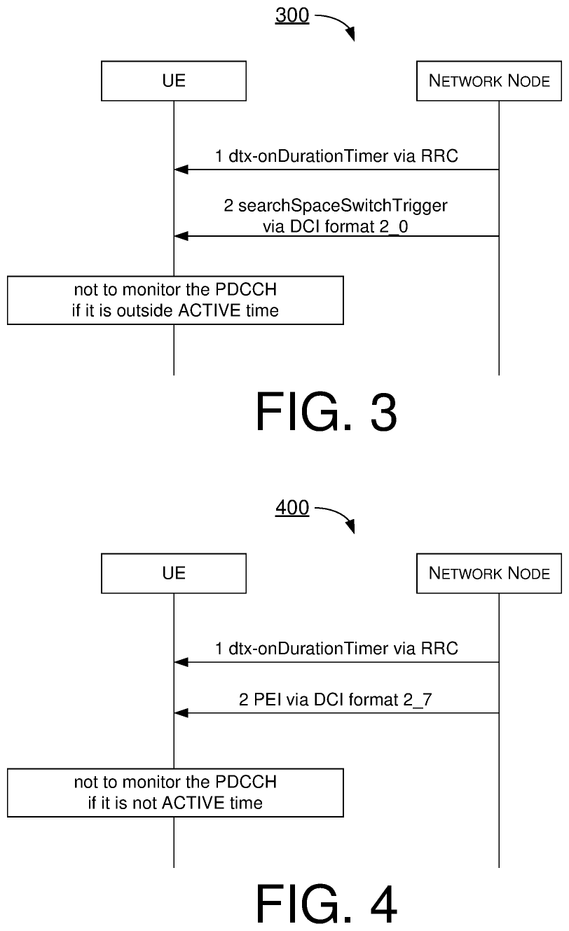

FIG. 3 illustrates an example scenario 300 of skipping PDCCH monitoring under schemes in accordance with implementations of the present disclosure. In some implementations, if the UE is provided by searchSpaceSwitchTrigger a location of a search space set group switching flag field in a DCI format 2_0, for a serving cell where the UE has active DL BWP with SCS configuration, and if the UE detects a DCI format 2_0 and a value of the search space set group switching flag field in the DCI format 2_0 is 0, UE may start monitoring PDCCH according to search space sets with group index 0 if a DRX or a DTX group is in active time (and stop or skip monitoring PDCCH if it is outside active time), and stop or skip monitoring PDCCH according to search space sets with group index 1, for the serving cell.

In some implementations, if the UE is provided by searchSpaceSwitch Trigger, and if the UE detects a DCI format 2_0 and a value of the search space set group switching flag field in the DCI format 2_0 is 1, the UE may start monitoring PDCCH according to search space sets with group index 1 if a DRX or a DTX group is in Active Time, and stop or skip monitoring PDCCH according to search space sets with group index 0, for the serving cell.

In some implementations, if the UE is provided by searchSpaceSwitchTrigger, and if the UE monitors PDCCH for a serving cell according to search space sets with group index 1, the UE may start monitoring PDCCH for the serving cell according to search space sets with group index 0 if a DRX or a DTX group is in Active Time, and stop or skip monitoring PDCCH according to search space sets with group index 1, for the serving cell.

Regarding PDCCH monitoring for early indication of paging, in some implementations, the UE may be provided the following for detection of a DCI format 2_7 in an RRC idle state or in an RRC inactive state, including: (1) a search space set, by pei-SearchSpace, to monitor PDCCH for detection of DCI format 2_7 according to a Type2A-PDCCH CSS set; or (2) a number of frames, by pei-FrameOffset, from the start of a frame to the start of a first paging frame of paging frames associated with a number of PDCCH monitoring occasions for DCI format 2_7; or (3) a number of symbols, by firstPDCCH-MonitoringOccasionOfPEI-O, from the start of the frame to the start of the first PDCCH monitoring occasion for DCI format 2_7; or (4) a size, by payloadSizeDCI-2-7; or (5) a number of subgroups per paging occasion by subgroupsNumPerPO; or (6) a number of paging occasions associated with the number of PDCCH monitoring occasions for DCI format 2_7 by po-NumPerPEI.

FIG. 4 illustrates an example scenario 400 of skipping PDCCH monitoring under schemes in accordance with implementations of the present disclosure. In some implementations, the UE may be provided the dtx-onDurationTimer via RRC signaling and provided the PEI via DCI format 2_7 and may determine not to monitor the PDCCH it is not active time.

### Illustrative Implementations

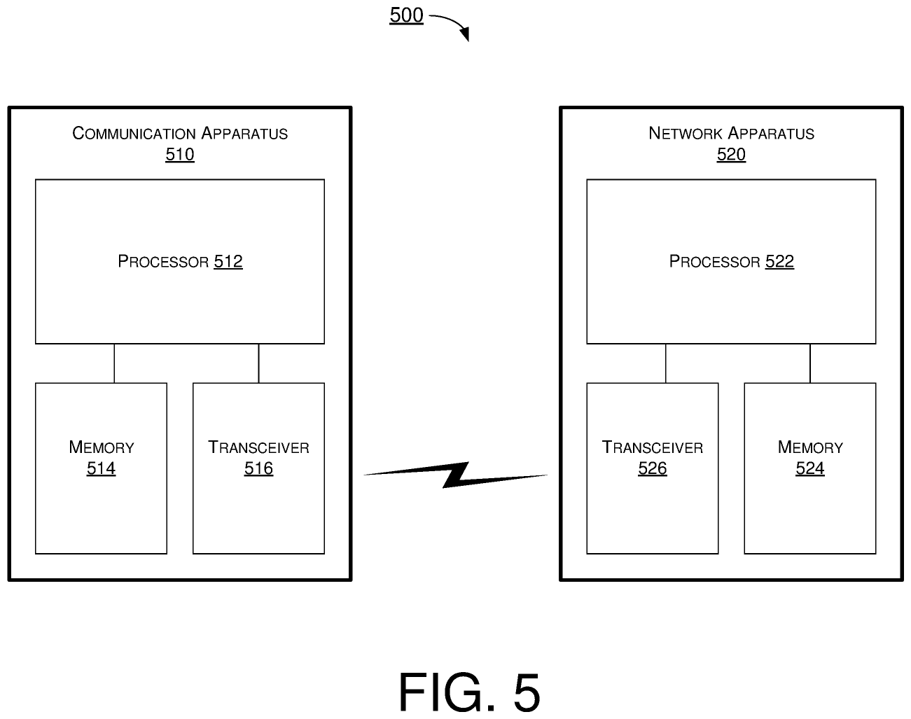

FIG. 5 illustrates an example communication system 500 having an example communication apparatus 510 and an example network apparatus 520 in accordance with an implementation of the present disclosure. Each of the communication apparatus 510 and the network apparatus 520 may perform various functions to implement schemes, techniques, processes and methods described herein pertaining to network power saving with respect to user equipment and network apparatus in mobile communications, including scenarios/schemes described above as well as the process 600 described below.

The communication apparatus 510 may be a part of an electronic apparatus, which may be a UE such as a portable or mobile apparatus, a wearable apparatus, a wireless communication apparatus or a computing apparatus. For instance, the communication apparatus 510 may be implemented in a smartphone, a smartwatch, a personal digital assistant, a digital camera, or a computing equipment such as a tablet computer, a laptop computer or a notebook computer. The communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, the communication apparatus 510 may be implemented in a smart thermostat, a smart fridge, a smart door lock, a wireless speaker or a home control center. Alternatively, the communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 510 may include at least some of those components shown in FIG. 5 such as a processor 512, for example. The communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

The network apparatus 520 may be a part of a network apparatus, which may be a network node such as a satellite, a base station, a small cell, a router or a gateway. For instance, the network apparatus 520 may be implemented in an eNodeB in an LTE network, in a gNB in a 5G/NR, IoT, NB-IoT or IIoT network or in a satellite or base station in a 6G network. Alternatively, the network apparatus 520 may be implemented in the form of one or more IC chips such as, for example and without limitation, one or more single-core processors, one or more multi-core processors, or one or more RISC or CISC processors. The network apparatus 520 may include at least some of those components shown in FIG. 5 such as a processor 522, for example. The network apparatus 520 may further include one or more other components not pertinent to the proposed scheme of the present disclosure (e.g., internal power supply, display device and/or user interface device), and, thus, such component(s) of the network apparatus 520 are neither shown in FIG. 5 nor described below in the interest of simplicity and brevity.

In one aspect, each of the processor 512 and the processor 522 may be implemented in the form of one or more single-core processors, one or more multi-core processors, or one or more CISC processors. That is, even though a singular term “a processor” is used herein to refer to the processor 512 and the processor 522, each of the processor 512 and processor the 522 may include multiple processors in some implementations and a single processor in other implementations in accordance with the present disclosure. In another aspect, each of the processor 512 and the processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 512 and the processor 522 is a special-purpose machine specifically designed, arranged and configured to perform specific tasks including autonomous reliability enhancements in a device (e.g., as represented by the communication apparatus 510) and a network (e.g., as represented by the network apparatus 520) in accordance with various implementations of the present disclosure.

In some implementations, the communication apparatus 510 may also include a transceiver 516 coupled to the processor 512 and capable of wirelessly transmitting and receiving data. In some implementations, the communication apparatus 510 may further include a memory 514 coupled to the processor 512 and capable of being accessed by the processor 512 and storing data therein. In some implementations, the network apparatus 520 may also include a transceiver 526 coupled to the processor 522 and capable of wirelessly transmitting and receiving data. In some implementations, the network apparatus 520 may further include a memory 524 coupled to the processor 522 and capable of being accessed by the processor 522 and storing data therein. Accordingly, the communication apparatus 510 and the network apparatus 520 may wirelessly communicate with each other via the transceiver 516 and the transceiver 526, respectively. To aid better understanding, the following description of the operations, functionalities and capabilities of each of the communication apparatus 510 and the network apparatus 520 is provided in the context of a mobile communication environment in which the communication apparatus 510 is implemented in or as a communication apparatus or a UE and the network apparatus 520 is implemented in or as a network node of a communication network.

In some implementations, the processor 512, which is communicatively coupled to the transceiver 516, may receive, via the transceiver 516, a configuration of a cell DTX from the network apparatus 520. The processor 512 may skip a monitoring activity during one or more non-active periods of the cell DTX of the network apparatus 520. The configuration may comprise information regarding at least one of a periodicity, a start slot or a start offset and an on duration with respect to the cell DTX.

In some implementations, the monitoring activity comprises a monitoring activity to monitor a PDCCH scrambled with a C-RNTI of the communication apparatus 510.

In some implementations, the monitoring activity comprises a monitoring activity to monitor a Type3-PDCCH CSS.

In some implementations, the processor 512 may receive, via the transceiver 516, a cell DTX activation or deactivation indication from the network apparatus 520 via a RRC signaling or a PDCCH-based signaling.

In some implementations, the PDCCH-based signaling comprises at least one of a DCI format 2_6 and a DCI format 2_7.

In some implementations, in receiving the configuration, the processor 512 may receive, via the transceiver 516, a RRC signaling to configure one or more cell DTX parameters. The one or more cell DTX parameters comprise at least one of the periodicity, the start slot or the start offset and the on duration.

In some implementations, the on duration is indicated by a cell DTX on duration timer.

In some implementations, the periodicity comprises at least one of a cell DTX long cycle and a cell DTX short cycle.

In some implementations, the processor 512 may receive, via the transceiver 516, a transmission activity to send an SR in an active period of a DRX and an active period of the cell DTX of the network apparatus 520; or skip a transmission of the SR during one or more non-active periods of the DRX or the one or more non-active periods of the cell DTX of the network apparatus 520.

In some implementations, the processor 512 may receive, via the transceiver 516, an indication of a new transmission from the network apparatus 520, and skip a monitoring activity to monitor a PDCCH occasion for the new transmission in an event that the PDCCH occasion is overlapped with one of the one or more non-active periods of the cell DTX.

### Illustrative Processes

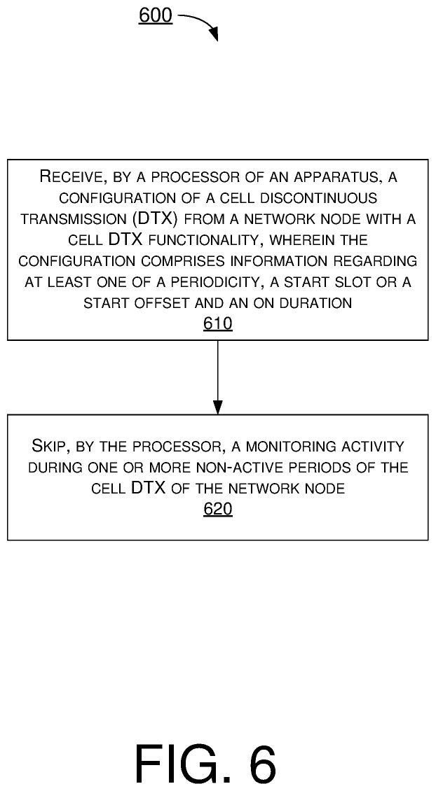

FIG. 6 illustrates an example process 600 in accordance with an implementation of the present disclosure. The process 600 may be an example implementation of above scenarios/schemes, whether partially or completely, with respect to network power saving with the present disclosure. The process 600 may represent an aspect of implementation of features of communication apparatus 510. The process 600 may include one or more operations, actions, or functions as illustrated by one or more of blocks 610 and 620. Although illustrated as discrete blocks, various blocks of the process 600 may be divided into additional blocks, combined into fewer blocks, or eliminated, depending on the desired implementation. Moreover, the blocks of the process 600 may be executed in the order shown in FIG. 6 or, alternatively, in a different order. The process 600 may be implemented by the communication apparatus 510 or any suitable UE or machine type devices. Solely for illustrative purposes and without limitation, the process 600 is described below in the context of communication apparatus 510. The process 600 may begin at block 610.

At 610, the process 600 may involve the processor 512 of the communication apparatus 510 receiving a configuration of a cell DTX from a network node with a cell DTX functionality. The configuration may comprise information regarding at least one of a periodicity, a start slot or a start offset and an on duration. The process 600 may proceed from 610 to 620.

At 620, the process 600 may involve the processor 512 skipping a monitoring activity during one or more non-active periods of the cell DTX of the network node.

In some implementations, the monitoring activity comprises a monitoring activity to monitor a PDCCH scrambled with a C-RNTI of the communication apparatus 510.

In some implementations, the monitoring activity comprises a monitoring activity to monitor a Type3-PDCCH CSS.

In some implementations, the process 600 may involve the processor 512 receiving a cell DTX activation or deactivation indication from the network node via a RRC signaling or a PDCCH-based signaling.

In some implementations, the PDCCH-based signaling comprises at least one of a DCI format 2_6 and a DCI format 2_7.

In some implementations, the process 600 may involve the processor 512 receiving a RRC signaling. The one or more cell DTX parameters comprise at least one of the periodicity, the start slot or the start offset and the on duration.

In some implementations, the on duration is indicated by a cell DTX on duration timer.

In some implementations, the periodicity comprises at least one of a cell DTX long cycle and a cell DTX short cycle.

In some implementations, the process 600 may involve the processor 512 performing a transmission activity to send a SR in an active period of a DRX and an active period of the cell DTX of the network node, or skipping a transmission of the SR during one or more non-active periods of the DRX or the one or more non-active periods of the cell DTX of the network node.

In some implementations, the process 600 may involve the processor 512 receiving an indication of a new transmission from the network node. The process 600 may involve the processor 512 skipping a monitoring activity to monitor a PDCCH occasion for the new transmission in an event that the PDCCH occasion is overlapped with one of the one or more non-active periods of the cell DTX.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a configuration of a cell discontinuous transmission (DTX) from a network node with a cell DTX functionality, wherein the configuration comprises information regarding at least one of a periodicity, a start slot or a start offset and an on duration; and
skipping, by the processor, a monitoring activity during one or more non-active periods of the cell DTX of the network node.

2. The method of claim 1, wherein the monitoring activity comprises a monitoring activity to monitor a physical downlink control channel (PDCCH) scrambled with a cell radio network temporary identifier (C-RNTI) of the apparatus.

3. The method of claim 1, wherein the monitoring activity comprises a monitoring activity to monitor a Type3-PDCCH common search space (CSS).

4. The method of claim 1, further comprising:
receiving, by the processor, a cell DTX activation or deactivation indication from the network node via a radio resource control (RRC) signaling or a PDCCH-based signaling.

5. The method of claim 4, wherein the PDCCH-based signaling comprises at least one of a downlink control information (DCI) format 2_6 and a DCI format 2_7.

6. The method of claim 1, wherein the receiving of the configuration of the cell DTX comprises:
receiving, by the processor, a radio resource control (RRC) signaling to configure one or more cell DTX parameters,
wherein the one or more cell DTX parameters comprise at least one of the periodicity, the start slot or the start offset and the on duration.

7. The method of claim 6, wherein the on duration is indicated by a cell DTX on duration timer.

8. The method of claim 6, wherein the periodicity comprises at least one of a cell DTX long cycle and a cell DTX short cycle.

9. The method of claim 1, further comprising:
performing, by the processor, a transmission activity to send a scheduling request (SR) in an active period of a discontinuous reception (DRX) and an active period of the cell DTX of the network node; or
skipping, by the processor, a transmission of the SR during one or more non-active periods of the DRX or the one or more non-active periods of the cell DTX of the network node.

10. The method of claim 1, further comprising:
receiving, by the processor, an indication of a new transmission from the network node; and
skipping, by the processor, a monitoring activity to monitor a PDCCH occasion for the new transmission in an event that the PDCCH occasion is overlapped with one of the one or more non-active periods of the cell DTX.

11. An apparatus, comprising:
a transceiver which, during operation, wirelessly communicates with at least one network node; and
a processor communicatively coupled to the transceiver such that, during operation, the processor performs operations comprising:
receiving, via the transceiver, a configuration of a cell discontinuous transmission (DTX) from the network node with a cell DTX functionality, wherein the configuration comprises information regarding at least one of a periodicity, a start slot or a start offset and an on duration; and
skipping a monitoring activity during one or more non-active periods of the cell DTX of the network node.

12. The apparatus of claim 11, wherein the monitoring activity comprises a monitoring activity to monitor a physical downlink control channel (PDCCH) scrambled with a cell radio network temporary identifier (C-RNTI) of the apparatus.

13. The apparatus of claim 11, wherein the monitoring activity comprises a monitoring activity to monitor a Type3-PDCCH common search space (CSS).

14. The apparatus of claim 11, during operation, the processor further performs operations comprising:
receiving, via the transceiver, a cell DTX activation or deactivation indication from the network node via a radio resource control (RRC) signaling or a PDCCH-based signaling.

15. The apparatus of claim 14, wherein the PDCCH-based signaling comprises at least one of a downlink control information (DCI) format 2_6 and a DCI format 2_7.

16. The apparatus of claim 11, wherein, in receiving the configuration, the processor further performs operation comprising:
receiving, via the transceiver, a radio resource control (RRC) signaling to configure one or more cell DTX parameters,
wherein the one or more cell DTX parameters comprise at least one of the periodicity, the start slot or the start offset and the on duration.

17. The apparatus of claim 16, wherein the on duration is indicated by a cell DTX on duration timer.

18. The apparatus of claim 16, wherein the periodicity comprises at least one of a cell DTX long cycle and a cell DTX short cycle.

19. The apparatus of claim 11, wherein, during operation, the processor further performs operation comprising:
performing, via the transceiver, a transmission activity to send a scheduling request (SR) in an active period of a discontinuous reception (DRX) and an active period of the cell DTX of the network node; or
skipping a transmission of the SR during one or more non-active periods of the DRX or the one or more non-active periods of the cell DTX of the network node.

20. The apparatus of claim 11, wherein, during operation, the processor further performs operation comprising:
receiving, via the transceiver, an indication of a new transmission from the network node; and
skipping a monitoring activity to monitor a PDCCH occasion for the new transmission in an event that the PDCCH occasion is overlapped with one of the one or more non-active periods of the cell DTX.
